(19) United States
(12) Patent Application Publication
(10) Pub. No.: US 2026/0163616 A1
(43) Pub. Date: Jun. 11, 2026

(54) BEAMFORMING TRANSMISSION AND RECEPTION SYSTEM BASED ON THREE-WAY SPLITTER

(71) Applicant: KOREA ADVANCED INSTITUTE OF SCIENCE AND TECHNOLOGY, Daejeon (KR)

(72) Inventors: Sanggug LEE, Daejeon (KR); Hyoryeong JEON, Daejeon (KR)

(73) Assignee: KOREA ADVANCED INSTITUTE OF SCIENCE AND TECHNOLOGY, Daejeon (KR)

(21) Appl. No.: 19/309,786

(22) Filed: Aug. 26, 2025

(30) Foreign Application Priority Data
Dec. 6, 2024 (KR) 10-2024-0180122
Jun. 4, 2025 (KR) 10-2025-0072949

(51) Int. Cl. H04B 7/0426; H01Q 3/36; H04B 7/06

(52) U.S. Cl. CPC H04B 7/043; H01Q 3/36; H04B 7/0617

(57) ABSTRACT

Provided is a beamforming transmission and reception system based on a three-way splitter. The beamforming transmission and reception system may include a beamforming unit including a three-way splitter, and a local oscillator (LO) transmitter configured to transmit a reference LO signal, wherein the three-way splitter is configured to branch an input signal into three output paths.

### CROSS-REFERENCE TO RELATED APPLICATION

This application is based on and claims priority under 35 U.S.C. § 119 to Korean Patent Application No. 10-2024-0180122, filed on Dec. 6, 2024, and No. 10-2025-0072949, filed on Jun. 4, 2025, in the Korean Intellectual Property Office, the disclosure of which is incorporated by reference herein in its entirety.

### BACKGROUND

### 1. Field

The present disclosure relates to a beamforming transmission and reception system based on a three-way splitter.

### 2. Description of the Related Art

Beamforming transmission and reception systems are a technology which concentrates wireless signals to specific spatial directions or selectively receives signals through a plurality of antennas, thereby improving signal quality and suppressing interference, and are one of the core components of modern wireless communication systems. Beamforming technology is widely recognized as a method which may maximize communication performance, especially in high-frequency communication environments where bandwidth obtainment is challenging, and is extensively applied in 5G and 6G mobile communications, satellite communications, radar sensors, environmental recognition systems for autonomous vehicles, or military communication systems.

To implement beamforming systems, precisely phase-synchronized local oscillator (LO) signals need to be supplied to each antenna element. In the related art, this has been achieved by using individual phase-locked loop (PLL) circuits for each transmission and reception path or distributing reference frequencies through complex clock distribution networks. These LO synchronization methods of the related art may provide a certain performance level, but in large-scale multiple input multiple output (MIMO) environments with a plurality of channels, circuit complexity, power consumption, and system area increase may occur. Particularly in high-frequency bands, additional technical burdens are inevitably accompanied by losses in clock transmission lines, phase jitter, and maintaining signal compatibility.

Moreover, in transceiver structures, LO signals and radio frequency (RF) signals often share the same path, which may cause frequency interference between the two signals or inefficient processing of reflected signals. In particular, in most systems, isolated ports of splitter structures have been used in the related art merely to prevent losses or to discard unwanted signals, resulting in inefficient structures with low utilization of LO signals.

Therefore, a technical demand exists in the industry for beamforming transmission and reception systems which may actively utilize reflected LO components. In relation to this, Korean Patent Publication No. 10-2022-0051585 discloses a method and apparatus for performing hybrid beamforming in a multi-antenna full-duplex communication system.

### SUMMARY

The technical problem to be solved by the disclosure relates to a beamforming transmission and reception system based on a three-way splitter.

The technical problems of the disclosure are not limited to the technical problems mentioned above, and other unmentioned technical problems may be clearly understood by those of ordinary skill in the art from the following description.

According to an embodiment of the disclosure for solving the aforementioned technical problem, a beamforming transmission and reception system based on a three-way splitter is provided. The beamforming transmission and reception system includes a beamforming unit including a three-way splitter, and a local oscillator (LO) transmitter configured to transmit a reference LO signal, wherein the three-way splitter is configured to branch an input signal into three output paths.

In another embodiment, the three-way splitter may include an input port to which an input signal is applied, a first output port from which the input signal from the input port is output as a signal of a first phase, a second output port from which the input signal from the input port is output as a signal of a second phase having a certain phase difference from the first phase, and a third output port from which signals reflected from circuits connected to the first output port and the second output port, respectively, are output.

In another embodiment, each of the first output port and the second output port may be set to be matched in a radio frequency (RF) signal band and set to be reflected in an LO signal band, and the third output port may be configured such that LO signals reflected from the first output port and the second output port are combined and output.

In another embodiment, the beamforming unit may further include a mixer configured to convert frequencies of an input LO signal and RF signal, a phase shifter connected to supply the LO signal to the mixer, and an amplifier configured to amplify the LO signal phase-adjusted by the phase shifter.

In another embodiment, the signal output from the third output port may be supplied to the mixer through the phase shifter and the amplifier, and the mixer may be configured to convert a received RF signal to a baseband signal or convert a baseband signal to an RF signal.

In another embodiment, the beamforming unit including the three-way splitter further may include a beamforming signal transmitter configured to generate a beamforming RF signal and transmit the beamforming RF signal to the outside, or a beamforming signal receiver configured to receive a beamformed RF signal from the outside and process the beamformed RF signal.

In another embodiment, the beamforming signal transmitter may be further configured to up-convert the baseband signal to an RF signal by mixing the baseband signal with an LO signal supplied through the third output port, and transmit the RF signal to the outside through the first output port or the second output port.

In another embodiment, the beamforming signal transmitter may be further configured to perform phase adjustment on the reference LO signal through a channel-specific phase shifter, wherein a phase adjustment value may be controlled according to a transmission beamforming directionality.

In another embodiment, the beamforming signal receiver may be further configured to receive an RF signal received from the outside through the first output port or the second output port, and down-convert the RF signal to a baseband signal by mixing the RF signal with an LO signal supplied through the third output port.

In another embodiment, the beamforming signal receiver may be further configured to perform phase adjustment on the LO signal output from the third output port through the phase shifter, and adjust a signal reception sensitivity from a specific direction by setting a reception directionality according to a phase adjustment value.

Other specific details of the disclosure are included in the detailed description and drawings.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 is a diagram of a beamforming transmission and reception system according to an embodiment of the disclosure;

FIG. 2 is a block diagram of a beamforming unit according to an embodiment of the disclosure;

FIG. 3 is a block diagram of a three-way splitter according to an embodiment of the disclosure;

FIG. 4 is a diagram for explaining a beamforming unit including a three-way splitter according to an embodiment of the disclosure;

FIGS. 5 and 6 are diagrams for explaining a beamforming signal transmitter according to an embodiment of the disclosure; and

FIGS. 7 and 8 are diagrams for explaining a beamforming signal receiver according to an embodiment of the disclosure.

### DETAILED DESCRIPTION

Effects and features of the disclosure, and methods for achieving them will be clarified with reference to embodiments described below in detail with reference to the accompanying drawings. However, the disclosure is not limited to the embodiments presented below, but may be implemented in various different forms, and should be understood to include all modifications, equivalents, or substitutes which fall within the spirit and technical scope of the disclosure. The embodiments presented below are to make the disclosure complete and are provided to fully inform those of ordinary skill in the art of the scope of the disclosure. In the description of the disclosure, when it is determined that specific explanations of known technologies may obscure the essence of the disclosure, the specific explanations are omitted.

Terms used in the specification are used only to describe specific embodiments and are not intended to limit the disclosure. Unless otherwise defined, all terms used in the specification have the same meaning as generally understood by those of ordinary skill in the art to which the disclosure pertains.

As used in the specification, the singular forms include the plural forms unless the context clearly indicates otherwise. Also, terms “include”, “comprise”, and “have” are intended to specify the presence of features, numbers, steps, operations, components, parts, or combinations thereof described in the specification, and do not preclude the presence or possibility of addition of one or more other features, numbers, steps, operations, components, parts, or combinations thereof.

Moreover, terms including ordinal numbers, such as “first” and “second”, used in the specification, may be used to describe various components, but the components should not be limited by these terms. The terms are used only for the purpose of distinguishing one component from another.

Phrases “in an embodiment”, “according to an embodiment”, “in relation to an embodiment”, and “according to the implementation of an embodiment” used in the specification do not necessarily refer to the same embodiment. Moreover, “embodiment” throughout the specification is an arbitrary distinction to facilitate the explanation of the disclosure, and each embodiment does not need to be mutually exclusive. For example, components mentioned for describing an embodiment may be applied and/or implemented in other embodiments, and may be applied and/or implemented with modifications within the scope of the disclosure.

Some embodiments of the disclosure may be represented by functional block components and various processing steps. Some or all of these functional blocks may be implemented by various numbers of hardware and/or software components which perform specific functions. For example, the functional blocks of the disclosure may be implemented by one or more microprocessors or by circuit components for specific functions.

Also, for example, the functional blocks of the disclosure may be implemented in various programming or scripting languages. The functional blocks may be implemented as algorithms executed on one or more processors. Moreover, the disclosure may employ technologies of the related art for electronic environment settings, signal processing, and/or data processing. Terms “mechanism”, “element”, “means”, and “component” may be used broadly and are not limited to mechanical and physical components. Also, terms “ . . . or/er” and “module” refer to a unit which processes at least one function or operation, which may be implemented in hardware or software, or a combination of hardware and software.

Furthermore, connection lines or connection members between components shown in the drawings are merely examples of functional connections and/or physical or circuit connections. In actual apparatuses, connections between components may be represented by various replaceable or additional functional connections, physical connections, or circuit connections.

Also, some components in the drawings may have been somewhat exaggerated in size or proportion. Moreover, components shown in certain drawings may not be shown in other drawings.

The disclosure will be described in detail with reference to the accompanying drawings below.

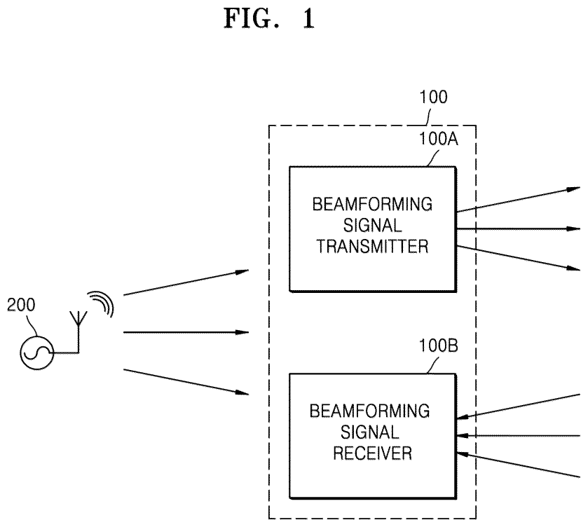

FIG. 1 is a diagram of a beamforming transmission and reception system according to an embodiment of the disclosure.

Referring to FIG. 1, a beamforming system according to an embodiment of the disclosure may include a beamforming unit 100 and a local oscillator (LO) transmitter 200.

The system shown in FIG. 1 is based on an embodiment, and the components are not limited to the embodiment shown in FIG. 1, and may be added, modified, or deleted as needed.

In an embodiment, the beamforming unit 100 may receive an LO signal radiated over-the-air from the external LO transmitter 200. The beamforming unit 100 may include an integrated transmission and reception circuit module which performs a beamforming transmission or reception function by supplying the received LO signal to an internal phase control circuit and a mixer.

The beamforming unit 100 may include a plurality of channels or antenna elements, and each of the channels may be configured to have an independent phase shifter and amplification circuit for directional control.

In an embodiment, the beamforming unit 100 may include a three-way splitter. In this case, the three-way splitter may include a splitter based on a 90° hybrid coupler. The three-way splitter of the disclosure may include a splitter which has a characteristic of a 90-degree phase difference between output ports and may utilize, as an output port, an isolated port which has been previously used for dumping and absorption purposes. For example, the three-way splitter of the disclosure may be configured to include one input port and three output ports (e.g., a thru port, a coupled port, and an isolated port), enabling an input signal to be branched into three paths.

In some embodiments, a signal output through an additional output port (e.g., an isolated port) may be reflected and output to the corresponding port in a specific frequency band (e.g., an LO signal band) according to a circuit component designed with frequency-selective reflection characteristics. The output signal may be transmitted to a subsequent circuit, undergo phase adjustment and amplification, and then be used as a reference signal in a mixer of a transmission and reception path. Through this configuration, the disclosure may increase the utilization of circuit resources by using all splitter output ports as valid signal paths and simplify the distribution structure of reference LO signals.

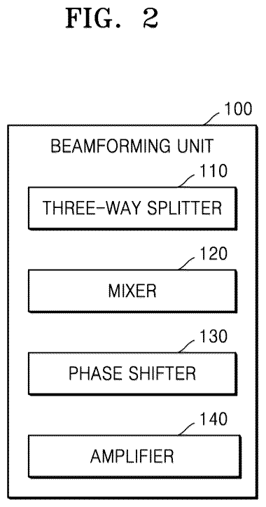

A hardware component of the beamforming unit 100 will be described below with reference to FIGS. 2 through 4.

In an embodiment, the LO transmitter 200 may generate a reference LO signal and transmit the reference LO signal over-the-air. In this case, a plurality of beamforming units 100 may wirelessly receive the same reference LO signal, thereby unifying the phase reference of the entire system and simplifying channel synchronization. This configuration may be utilized in a MIMO environment including a plurality of beamforming units and may replace a complex internal phase-locked loop (PLL) circuit or wired synchronization signal distribution structure.

Specifically, in the overall system of the disclosure, after the reference LO signal is radiated over-the-air from the external LO transmitter 200 and received by the beamforming unit 100, the beamforming unit 100 may separate an LO signal and a radio frequency (RF) signal according to frequency bands, and perform frequency conversion of transmission and reception signals in the mixer through the phase-adjusted and amplified LO signal, thereby enabling beamforming transmission and reception in a desired direction.

In various embodiments, the beamforming unit 100 may include a beamforming signal transmitter 100A and a beamforming signal receiver 1001B.

The beamforming signal transmitter 100A may include a transmission circuit component capable of mixing the reference LO signal received from the external LO transmitter 200 with an internal baseband signal to up-convert the mixed signal to an RF signal, and radiating the up-converted RF signal in a specific direction through a transmission antenna.

In addition, the beamforming signal transmitter 100A may include a three-way splitter to branch an input signal into the thru port, the coupled port, and the isolated port, and may generate an RF signal for transmission by amplifying a reflected LO signal output from the isolated port through a phase shifter and a narrowband amplifier and then supplying the amplified reflected LO signal to the mixer.

The beamforming signal transmitter 100A of the disclosure may have a simpler structure than beamforming signal transmitters of the related art including an internal LO generation circuit or a PLL-based phase synchronization circuit, facilitate phase synchronization between channels, and increase the precision of transmission beamforming.

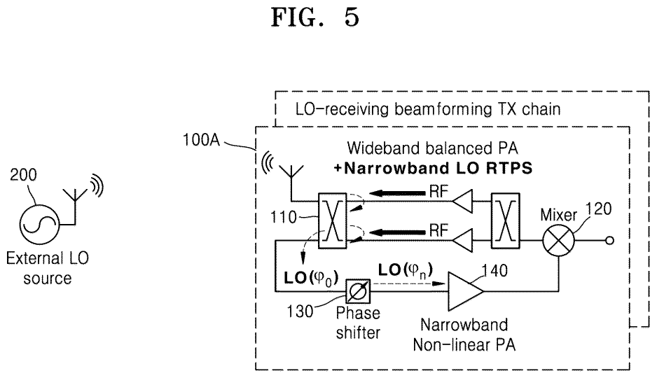

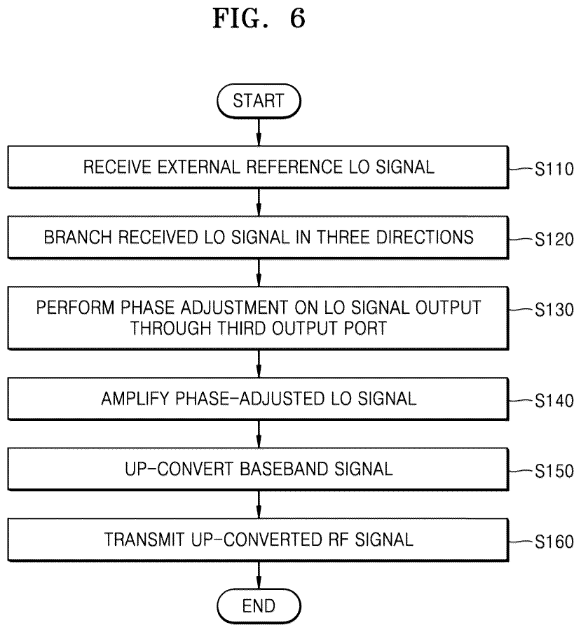

Hereinafter, a specific description of the configuration of the beamforming signal transmitter 100A will be provided below with reference to FIGS. 5 and 6.

The beamforming signal receiver 100B may include a reception circuit component which receives an RF signal, which is an external communication signal, through an antenna, and down-converts the RF signal to a baseband signal through mixing with the reference LO signal received from the external LO transmitter 200.

The beamforming signal receiver 100B also may separate an RF signal and an LO signal through the three-way splitter, wherein the LO signal may be reflected and output through the isolated port, and the LO signal may be corrected through a phase shifter and an amplifier and then input to the mixer.

In some embodiments, RF signals branched through the thru port and the coupled port may be low-noise amplified through a low noise amplifier (LNA) and then mixed with the phase-adjusted LO signal in the mixer, thereby enabling the obtainment of a baseband signal centered on components in a desired reception direction.

The structure of the beamforming signal receiver 100B of the disclosure allows for independent phase control for transmission and reception paths while an external LO reference signal is shared, and provides high synchronization stability and structural simplicity even in high-frequency bands, and thus may be easily utilized in various high-frequency application environments, such as large-scale multiple antenna (MIMO) systems, high-resolution radars, or satellite communications.

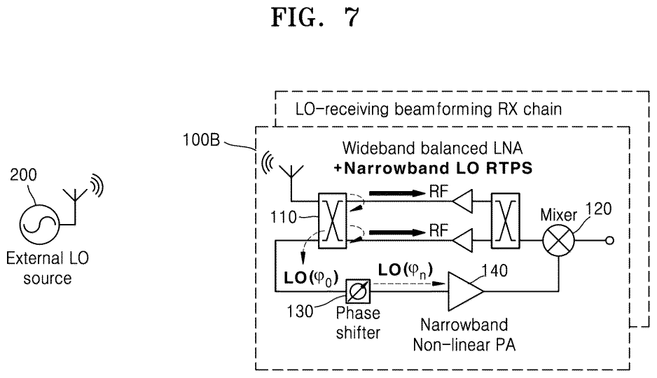

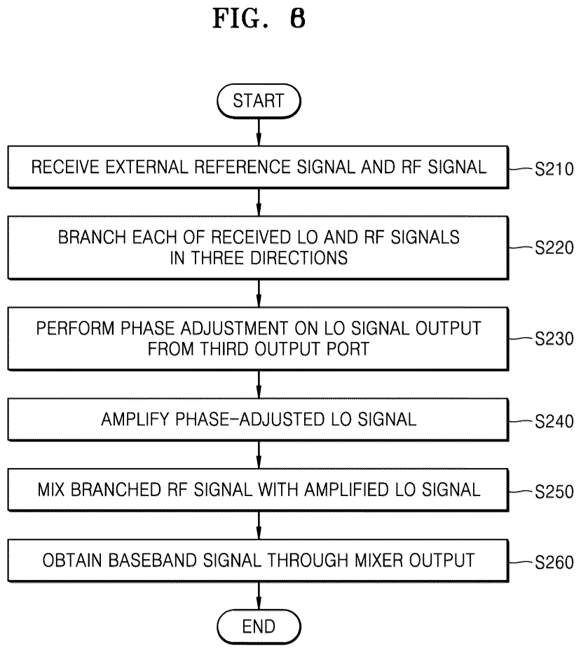

Hereinafter, a specific description of the configuration of the beamforming signal receiver 100B will be provided below with reference to FIGS. 7 and 8.

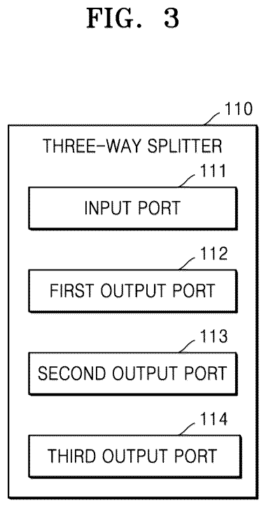

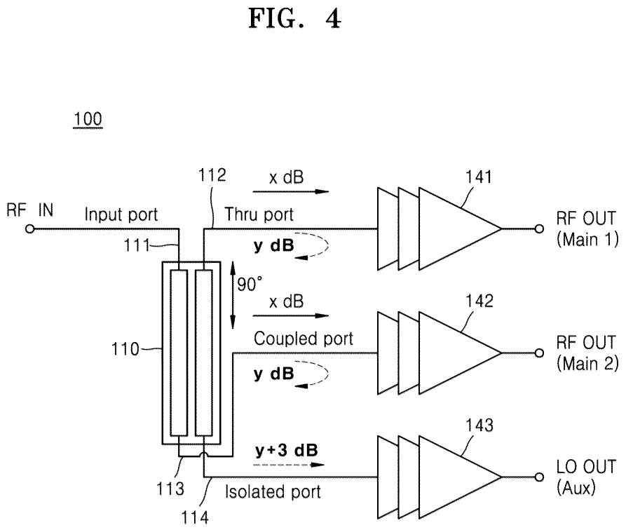

FIG. 2 is a block diagram of a beamforming unit according to an embodiment of the disclosure. FIG. 3 is a block diagram of a three-way splitter according to an embodiment of the disclosure. FIG. 4 is a diagram for explaining a beamforming unit including a three-way splitter according to an embodiment of the disclosure.

Referring to FIG. 2, the beamforming unit 100 according to an embodiment of the disclosure may include a three-way splitter 110, a mixer 120, a phase shifter 130, and an amplifier 140. In addition, referring to FIG. 3, the three-way splitter 110 may include an input port 111, a first output port 112, a second output port 113, and a third output port 114. In this case, FIGS. 2 and 3 illustrate only components related to the embodiments of the disclosure. Accordingly, those of ordinary skill in the art to which the disclosure pertains would understand that components other than those shown in FIGS. 2 and 3 may be further included as other general components.

In an embodiment, the three-way splitter 110 may include a splitter based on a 90° hybrid coupler.

Specifically, the three-way splitter 110 may include the input port 111 to which an input signal is applied, the first output port 112 from which the input signal from the input port 111 is output with a first phase, the second output port 113 from which the input signal from the input port 111 is output as a signal of a second phase having a certain phase difference (e.g., 90 degrees) from the first phase, and the third output port 114 from which signals reflected from circuits connected to the first output port 112 and the second output port 113, respectively, are output.

For example, referring to FIG. 4, the first output port 112 may correspond to the thru port of the 90° hybrid coupler, the second output port 113 may correspond to the coupled port, and the third output port 114 may correspond to the isolated port which has been previously used for dumping or absorption purposes. In the disclosure, the isolated port (e.g., a third output port) may be utilized as an active output path and configured as a path for separation and utilization of the reference LO signal.

In an embodiment, each of the first output port 112 and the second output port 113 may be set to be matched in an RF signal band and set to be reflected in an LO signal band.

Specifically, the first output port 112 and the second output port 113 may be designed to be matched through a termination circuit or an impedance matching circuit in the RF signal band. The RF signal may be set to be output toward a port without loss, and in the LO signal band. the first output port 112 and the second output port 113 may be designed to be reflected by fixing a circuit impedance. For example, in case that the RF signal is included in a frequency band f_RF, a termination impedance of the port may be set to be matched based on an input port, and in a frequency f_LO band including an LO signal, the termination impedance may be set to be mismatched such that reflection is induced.

In some embodiments, the third output port 114 may be configured such that LO signals reflected from the first output port 112 and a second output port 113 are combined and output.

Specifically, the third output port 114 may be configured such that LO signals reflected from circuits connected to the first output port 112 and the second output port 113, respectively, are combined and output while a 90-degree phase difference is maintained. For example, due to the structure of the hybrid coupler, reflected LO components are concentrated toward the isolated port, and a signal output to the isolated port may pass through the phase shifter and the amplifier and then be supplied as an LO reference signal to the mixer.

Through this, the disclosure may functionally utilize all output ports of a splitter by actively utilizing the isolated port which has not been utilized previously, and may secure phase precision while transmission paths of the reference LO signal are minimized.

More specifically, FIG. 4 illustrates a diagram for explaining a beamforming unit including a three-way splitter according to an embodiment of the disclosure.

Referring to FIG. 4, the beamforming unit 100 of the disclosure may be configured with a structure which distinguishes between RF signals and external LO signals with respect to the three-way splitter 110 and utilizes only the LO signals through a specific output port.

As described above, the three-way splitter 110 may include the input port 111, the first output port 112 corresponding to the thru port, the second output port 113 corresponding to the coupled port, and the third output port 114 corresponding to the isolated port.

An RF signal received from the outside or an LO signal radiated over-the-air from the external LO transmitter 200 may be input into the beamforming unit 100 through the input port 111, and these signals may be branched into different output paths in the three-way splitter 110.

First, the first output port 112 and the second output port 113 may each have a path loss of x dB level and may be output with a 90-degree phase difference. In this case, a first amplifier 141 may be connected to the first output port 112, and a second amplifier 142 may be connected to the second output port 113. In this regard, each of the first amplifier 141 and the second amplifier 142 may be configured as a power amplifier (PA) in case that the beamforming unit 100 is configured as a transmitter, and may be configured as an LNA in case that the beamforming unit 100 is configured as a receiver.

In the disclosure, by adjusting the impedance of each of the first amplifier 141 and the second amplifier 142, matching may be achieved in an RF band, and signals may be reflected in an LO band.

For example, an LO signal applied to each of the first amplifier 141 and the second amplifier 142 may be reflected back into the three-way splitter 110, and a reflection coefficient may be set such that an RF signal is output as it is. For example, a reflection coefficient for an LO signal frequency band may be set to be close to 1, and a reflection coefficient for an RF signal frequency band may be set to be close to 0.

Accordingly, a reflected LO signal may be concentrated and output to the third output port 114 (isolated port) according to the operating principle of the 90° hybrid coupler. In this case, the third output port 114 was a path which has been previously used for dumping purposes, but in the disclosure, the third output port 114 has been redesigned as a utilization path for supplying the LO reference signal to an internal mixer.

For example, an LO signal output to the third output port 114 may be adjusted to a preset phase through a narrowband phase shifter, and then amplified through a narrowband amplifier 143 and supplied to the mixer. The phase shifter and the narrowband amplifier 143 used herein may have narrowband characteristics designed to operate stably only in a specific frequency band of the LO signal, thereby increasing the precision of phase control and suppressing unnecessary signal distortion or out-of-band noise.

Therefore, the structure of the three-way splitter 110 shown in FIG. 4 may be configured to separate RF and LO signals received from the outside according to frequency bands in a single coupler-based structure, and to supply only the separated LO signal to the mixer through a phase control and amplification path, thereby stably setting a phase reference for the entire beamforming transmission and reception path. This structure enables the distribution and utilization of a common reference LO signal in an integrated transmission and reception structure or a MIMO environment, and may secure high-precision beamforming performance without a PLL.

FIGS. 5 and 6 are diagrams for explaining a beamforming signal transmitter according to an embodiment of the disclosure.

Referring to FIG. 5, the beamforming signal transmitter 100A may be configured as a transmission circuit which receives a reference LO signal radiated over-the-air from the external LO transmitter 200, up-converts a baseband signal to an RF signal based on the reference LO signal, and transmits the RF signal in a specific direction.

In this case, the beamforming signal transmitter 100A may be structured to synchronize a transmission chain by receiving an external LO signal and may form a transmission path including a wideband balanced PA and a narrowband LO real-time phase shifter (RTPS). Through this configuration, phase alignment between channels and precise beamforming may be performed without a PLL.

Specifically, the three-way splitter 110 of the beamforming signal transmitter 100A may receive the reference LO signal at the input port 111 and branch the reference LO signal into the first output port 112, the second output port 113, and the third output port 114. In this case, the first output port 112 and the second output port 113 may be output paths with a 90-degree phase difference from each other, and RF transmission may be performed through amplifiers (e.g., PAs) connected to the first output port 112 and the second output port 113, respectively.

More specifically, referring to FIG. 6, the beamforming signal transmitter 100A may receive an external reference LO signal (S110).

For example, the beamforming signal transmitter 100A may receive a reference LO signal radiated over-the-air from the LO transmitter 200 through an antenna and input the received LO signal to the input port 111 of the three-way splitter 110 inside the beamforming signal transmitter 100A.

Also, the beamforming signal transmitter 100A may branch the received LO signal in three directions (S120).

For example, the three-way splitter 110 may branch the received LO signal into the first output port 112, the second output port 113, and the third output port 114, wherein the first and second output ports may each be set to have a 90-degree phase difference and connected to an RF amplifier for transmission, and the third output port 114 may be utilized for a phase adjustment and amplification path by collecting the reflected LO signal.

Also, the beamforming signal transmitter 100A may perform phase adjustment on the LO signal output through the third output port 114 (S130).

For example, the LO signal output through the third output port 114 may be adjusted to a predefined phase according to channel-specific beamforming settings through the phase shifter 130, which may be used as a reference for controlling phase alignment between multiple channels and the directionality of a transmission beam in a subsequent mixing operation.

Also, the beamforming signal transmitter 100A may amplify the phase-adjusted LO signal (S140).

For example, the LO signal which has passed through the phase shifter 130 may be transmitted to the amplifier 140 and amplified to have sufficient output power suitable for supply to the mixer. In this case, the amplifier 140 may be, for example, a narrowband nonlinear PA designed to exhibit high-gain characteristics in a specific frequency band of the LO signal.

Also, the beamforming signal transmitter 100A may up-convert a baseband signal (S150).

For example, the amplified LO signal may be applied to the mixer 120 and mixed with a baseband signal input simultaneously, thereby up-converting the mixed signal to a transmission signal in a high-frequency RF band.

Also, the beamforming signal transmitter 100A may transmit the up-converted RF signal (S160).

For example, the up-converted RF signal may be output through an RF amplifier connected to each of the first output port 112 and the second output port 113 to a transmission antenna, and may be propagated in a specific direction according to beamforming technology.

Therefore, the beamforming signal transmitter 100A of the disclosure enables phase-aligned multi-channel LO supply without a PLL based on an external reference LO signal, and may maintain high phase precision while the circuit structure is simplified by utilizing a reflection path of the three-way splitter 110.

FIGS. 7 and 8 are diagrams for explaining a beamforming signal receiver according to an embodiment of the disclosure.

Referring to FIG. 7, the beamforming signal receiver 100B may be structured to receive a reference LO signal transmitted over-the-air from the external LO transmitter 200 and an RF signal received from an external communication apparatus, and selectively down-convert reception components in a specific direction based on the reference LO signal and the RF signal.

In this case, the beamforming signal receiver 100B may include a reception path which receives an external LO signal, utilizes the external LO signal as a phase reference for a reception chain, and simultaneously obtains a baseband signal through mixing with the received RF signal. In this process, the beamforming signal receiver 100B may include a wideband balanced LNA and a narrowband LO RTPS, and may be configured to perform independent phase control and amplification through paths branched according to signal frequency bands.

Specifically, the three-way splitter 110 may receive both LO and RF signals received from the outside through the input port 111 and branch the LO and RF signals into the first output port 112, the second output port 113, and the third output port 114. In this case, the first output port 112 and the second output port 113 may be designed to maintain matching for the RF signal band, allowing the received RF signal to be low-noise amplified through an LNA connected to each of the first output port 112 and the second output port 113. Also, the first output port 112 and the second output port 113 may have impedances set to induce reflection for the LO signal band, such that the reflected LO signal is concentrated and output to the third output port 114.

In some embodiments, the LO signal output from the third output port 114 may be adjusted to a phase defined according to channel-specific reception beamforming settings through the phase shifter 130, and may then be amplified to a power level suitable for the mixer 120 through the amplifier 140 which is configured as a narrowband nonlinear PA. The amplified LO signal may be transmitted to the mixer 120 and mixed with the amplified RF signal, allowing RF components corresponding to a specified reception beam direction to be down-converted to a baseband signal.

More specifically, referring to FIG. 8, the beamforming signal receiver 100B may receive an external reference LO signal and an RF signal (S210).

For example, a reference LO signal radiated over-the-air from the LO transmitter 200 may be received through the antenna of the beamforming signal receiver 100B, and simultaneously, an RF signal transmitted from an external communication apparatus may also be received through the antenna of the beamforming signal receiver 100B, allowing both signals to be input to the input port 111 of the three-way splitter 110.

Also, the beamforming signal receiver 100B may branch each of the received LO and RF signals in three directions (S220).

For example, the three-way splitter 110 may branch the input signal into the first output port 112, the second output port 113, and the third output port 114, wherein the first and second output ports 112 and 113 may be configured as paths which pass the RF signal, and the third output port 114 may be configured as a path where signals reflected in the LO signal frequency band are concentrated and output.

Also, the beamforming signal receiver 100B may perform phase adjustment on the LO signal output from the third output port 114 (S230).

For example, the LO signal output through the third output port 114 may be adjusted to a predefined phase for reception beam alignment between channels through the phase shifter 130, which may be utilized as an adjustment value to match the directionality of the received RF signal.

Also, the beamforming signal receiver 100B may amplify the phase-adjusted LO signal (S240).

For example, the LO signal which has passed through the phase shifter 130 may be amplified to a power level suitable for application to the mixer 120 through the nonlinear amplifier 140 having narrowband characteristics, and this amplifier may be designed to have fixed gain characteristics in the LO frequency band.

Also, the beamforming signal receiver 100B may mix the branched RF signal and the amplified LO signal (S250).

For example, RF signals branched through the first output port and the second output port may be low-noise amplified through respective LNAs and then transmitted to the mixer 120, and simultaneously mixed with the amplified LO signal to perform a down-conversion (mixing) operation.

Also, the beamforming signal receiver 100B may obtain a baseband signal through a mixer output (S260).

For example, the mixer 120 may output a baseband signal by extracting the frequency difference between the received RF signal and LO signal. In this case, the baseband signal may undergo subsequent processing, such as demodulation and interpretation, by the system.

Therefore, the beamforming signal receiver 100B of the disclosure may include a structure which may align phases between channels based on the external reference LO signal and precisely down-convert multi-channel RF reception. In particular, a path branching structure based on the three-way splitter by frequency band may be combined with a narrowband phase and amplification path, thereby achieving stable phase control without a PLL, and this structure may be usefully applied in high-frequency MIMO environments, satellite communications, or radar systems.

According to the disclosure, a beamforming transmission and reception system may be provided, which may flexibly adjust transmission and reception directionality by receiving a reference LO signal transmitted from the outside, separating LO signals and RF signals according to frequency bands through the three-way splitter, and supplying a reflected LO signal to the mixer through phase control and amplification processes. Through this, the disclosure enables stable phase synchronization and efficient frequency conversion even in high-frequency communication environments, simplifies the structure of the system, and secures scalability in multi-channel environments.

The effects of the disclosure are not limited to the aforementioned effects, and other effects not mentioned may be clearly understood by those of ordinary skill in the art from the description below.

In addition, embodiments according to the disclosure may be implemented in a form of a computer program which may be executed on a computer through various components, and the computer program may be recorded on a computer-readable medium. In this regard, the computer-readable medium may include a magnetic medium such as a hard disk, a floppy disk, or a magnetic tape, an optical recording medium such as a compact disk read-only memory (CD-ROM) or a digital video disk (DVD), a magneto-optical medium such as a floptical disk, or a hardware apparatus specially configured to store and execute program instructions, such as ROM, random-access memory (RAM), or a flash memory, but is not limited thereto.

In addition, the computer program may be specially designed and configured for the disclosure or may be known to and available to those of ordinary skill in the field of computer software. Examples of the computer program may include not only machine code, such as that produced by a compiler, but also high-level language code which may be executed by a computer using an interpreter or the like.

According to an embodiment, the method according to various embodiments of the disclosure may be provided as a part of a computer program product. The computer program product may be traded as a product between a seller and a buyer. The computer program product may be distributed in a form of a machine-readable storage medium (e.g., CD-ROM), or may be distributed online (e.g., downloaded or uploaded) through an application store (e.g., Play Store™) or directly between two user apparatuses. In the case of online distribution, at least a part of the computer program product may be at least temporarily stored or temporarily created in a machine-readable storage medium, such as a memory of a manufacturer's server, an application store's server, or a relay server.

Unless explicitly stating the order of steps constituting the method according to the disclosure or stating otherwise, the steps may be performed in an appropriate order. The disclosure is not necessarily limited to the order in which the steps are described. The use of all examples or exemplary terms (for example, etc.) in the disclosure is merely to explain the disclosure in detail, and the scope of the disclosure is not limited by the examples or exemplary terms unless limited by the claims. Also, those of ordinary skill in the art will appreciate that various modifications, combinations, and changes may be configured according to design conditions and factors within the scope of the appended claims or equivalents thereof.

Therefore, the spirit of the disclosure should not be limited to the embodiments described above, and all ranges that are equivalent to or equivalently changed from the following claims as well as these claims are within the scope of the spirit of the disclosure.

What is claimed is:

1. A beamforming transmission and reception system based on a three-way splitter, the beamforming transmission and reception system comprising:
a beamforming unit including a three-way splitter; and
a local oscillator (LO) transmitter configured to transmit a reference LO signal,
wherein
the three-way splitter is configured to branch an input signal into three output paths.

2. The beamforming transmission and reception system of claim 1, wherein
the three-way splitter comprises:
an input port to which an input signal is applied;
a first output port from which the input signal from the input port is output as a signal of a first phase;
a second output port from which the input signal from the input port is output as a signal of a second phase having a certain phase difference from the first phase; and
a third output port from which signals reflected from circuits connected to the first output port and the second output port, respectively, are output.

3. The beamforming transmission and reception system of claim 2, wherein
each of the first output port and the second output port is set to be matched in a radio frequency (RF) signal band and set to be reflected in an LO signal band, and
the third output port is configured such that LO signals reflected from the first output port and the second output port are combined and output.

4. The beamforming transmission and reception system of claim 3, wherein
the beamforming unit further comprises:
a mixer configured to convert frequencies of an input LO signal and RF signal;
a phase shifter connected to supply the LO signal to the mixer; and
an amplifier configured to amplify the LO signal phase-adjusted by the phase shifter.

5. The beamforming transmission and reception system of claim 4, wherein
the signal output from the third output port is supplied to the mixer through the phase shifter and the amplifier, and
the mixer is configured to convert a received RF signal to a baseband signal or convert a baseband signal to an RF signal.

6. The beamforming transmission and reception system of claim 2, wherein
the beamforming unit including the three-way splitter further comprises:
a beamforming signal transmitter configured to generate a beamforming RF signal and transmit the beamforming RF signal to the outside; or
a beamforming signal receiver configured to receive a beamformed RF signal from the outside and process the beamformed RF signal.

7. The beamforming transmission and reception system of claim 6, wherein
the beamforming signal transmitter is further configured to:
up-convert the baseband signal to an RF signal by mixing the baseband signal with an LO signal supplied through the third output port; and
transmit the RF signal to the outside through the first output port or the second output port.

8. The beamforming transmission and reception system of claim 7, wherein
the beamforming signal transmitter is further configured to
perform phase adjustment on the reference LO signal through a channel-specific phase shifter,
wherein a phase adjustment value is controlled according to a transmission beamforming directionality.

9. The beamforming transmission and reception system of claim 6, wherein
the beamforming signal receiver is further configured to:
receive an RF signal received from the outside through the first output port or the second output port; and
down-convert the RF signal to a baseband signal by mixing the RF signal with an LO signal supplied through the third output port.

10. The beamforming transmission and reception system of claim 9, wherein
the beamforming signal receiver is further configured to:
perform phase adjustment on the LO signal output from the third output port through the phase shifter; and
adjust a signal reception sensitivity from a specific direction by setting a reception directionality according to a phase adjustment value.
